(19) United States
(12) Patent Application Publication
(10) Pub. No.: US 2025/0377251 A1
(43) Pub. Date: Dec. 11, 2025

(54) IN-LINE HARMONIC REMOVAL PROCESSING WITH DISCOUNTED AVERAGING

(71) Applicant: Baker Hughes Holdings LLC, Houston, TX (US)

(72) Inventors: Andrew Henry Palmer, Carson City, NV (US); Justin William Bertrand, Puyallup, WA (US)

(21) Appl. No.: 19/227,990

(22) Filed: Jun. 4, 2025

Related U.S. Application Data
(60) Provisional application No. 63/656,667, filed on Jun. 6, 2024.

(51) Int. Cl. G01L 3/10

(52) U.S. Cl. CPC G01L 3/102

(57) ABSTRACT

A method of removing noise data from a sensor signal can include receiving, by at least one data processor, from a sensor configured to detect a variable physical property of a target object, a sensor signal corresponding to the detected variable physical property, receiving, by the at least one data processor, from a phase reference generator, phase reference information representative of a noise feature of the sensor signal, removing, by the at least one data processor, using a discounted averaging process and the phase reference information, periodic noise from the sensor signal to produce a noise-reduced signal, and providing, by the at least one data processor, the noise-reduced signal.

### CROSS-REFERENCE TO RELATED APPLICATIONS

This application claims priority to U.S. Provisional Patent Application No. 63/656,667, entitled “In-Line Harmonic Removal Processing with Discounted Averaging,” filed Jun. 6, 2024, the entire contents of which are hereby incorporated by reference herein.

### FIELD

The present disclosure relates generally to signal processing techniques for monitoring moving machinery and machine components such as rotating shafts.

### BACKGROUND

Many types of industrial machinery include mechanical components that are in motion when the machinery is in use. Examples of such moving components include shafts (e.g., motor shafts), pinons and other gears, connecting rods, and the like. Sensors are frequently employed to monitor the motion of such components to ensure that the components are functioning properly. Signal processing techniques, such as time synchronous averaging, are commonly used to reduce or remove unwanted noise (resulting, e.g., from electrical or mechanical runout) from sensor signals before the signals undergo further analysis. Mitigating noise in sensor signals can increase the efficiency of downstream signal processing and reduce the likelihood that noteworthy fluctuations in a signal (e.g., fluctuations indicating a mechanical issue with a machine component) are obscured.

### SUMMARY

In general, methods, systems, and non-transitory computer readable storage media for leveraging discounted averaging techniques to reduce or remove noise in sensor signals are described.

In one aspect, a method is described. The method can include receiving, by at least one data processor, from a sensor configured to detect a variable physical property of a target object, a sensor signal corresponding to the detected variable physical property. The sensor can be a magnetostrictive sensor or another type of sensor, and the target object can be a rotating shaft or another type of object. The method can further include receiving, by the at least one data processor, from a phase reference generator, phase reference information representative of a noise feature of the sensor signal, removing, by the at least one data processor, using a discounted averaging process and the phase reference information, periodic noise from the sensor signal to produce a noise-reduced signal, and providing, by the at least one data processor, the noise-reduced signal.

In some embodiments, the variable physical property is a time-varying physical property, a frequency-varying physical property, or a spatially-varying physical property. For example, the variable physical property can be a torsional vibration of the target object. In some embodiments, the method further includes detecting, by the sensor, the variable physical property.

In some embodiments, providing the noise-reduced signal can include controlling, by the at least one data processor, a display to display a waveform corresponding to the noise-reduced signal. In some embodiments, providing the noise-reduced signal can include storing, by the at least one data processor, the noise-reduced signal in a data storage device.

In another aspect, a system that includes at least one data processor and non-transitory memory is described. The non-transitory memory can store instructions configured to be executed by the at least one data processor to cause the at least one data processor to perform operations including receiving, from a sensor configured to detect a variable physical property of a target object, a sensor signal corresponding to the detected variable physical property, receiving, from a phase reference generator, phase reference information representative of a noise feature of the sensor signal, removing, using a discounted averaging process and the phase reference information, periodic noise from the sensor signal to produce a noise-reduced signal, and providing the noise-reduced signal.

In some embodiments, the system can include the sensor. The sensor can be an eddy current probe or another type of sensor. In some embodiments, the target object is a rotating shaft or another type of object. The variable physical property can be a time-varying physical property, a frequency-varying physical property, or a spatially-varying physical property.

In some embodiments, the system further includes a signal processor configured to process the sensor signal before the sensor signal is received by the at least one data processor. The signal processor can be a digital signal processor or another suitable signal processing device.

In some embodiments, the system includes a display communicatively coupled to the at least one data processor. The instructions stored by the memory can be configured to cause the at least one data processor to provide the noise-reduced signal by controlling the display to display a waveform corresponding to the noise-reduced signal.

In some embodiments, the system can include a second computer system configured to process the noise-reduced signal. The second computer system can be communicatively coupled to the at least one data processor through a network.

In another aspect, a non-transitory computer-readable memory storing instructions for execution by at least one data processor is described. The instructions, when executed by the at least one data processor, can cause the at least one data processor to perform operations including receiving, from a sensor configured to detect a variable physical property of a target object, a sensor signal corresponding to the detected variable physical property, receiving, from a phase reference generator, phase reference information representative of a noise feature of the sensor signal, removing, using a discounted averaging process and the phase reference information, periodic noise from the sensor signal to produce a noise-reduced signal, and providing the noise-reduced signal.

The details of one or more variations of the subject matter described herein are set forth in the accompanying drawings and the detailed description. Other features and advantages of the subject matter described herein will be apparent from the description, the drawings, and the claims.

### BRIEF DESCRIPTION OF THE DRAWINGS

The described subject matter will be more readily understood from the following detailed description in conjunction with the accompanying drawings, in which:

FIG. 1 is a block diagram illustrating an example input and a corresponding output to an exemplary discounted averaging processing system;

FIG. 2 is a block diagram of one embodiment of a discounted averaging processing system;

FIG. 3 is a block diagram of another embodiment of a discounted averaging processing system;

FIG. 4 is a plot comparing an example sensor signal prior to noise removal by a discounted averaging processing system and after noise removal by a discounted averaging processing system;

FIG. 5 is a flowchart illustrating one embodiment of a method of removing noise from a sensor signal using discounted averaging;

FIG. 6 is a flowchart illustrating one embodiment of a discounted averaging process; and

FIG. 7 is a block diagram of an exemplary computing system.

### DETAILED DESCRIPTION

Certain implementations will now be described to provide an overall understanding of the principles of the structure, function, manufacture, and use of the devices and methods disclosed herein. One or more examples of these implementations are illustrated in the accompanying drawings. Those skilled in the art will understand that the devices and methods specifically described herein and illustrated in the accompanying drawings are non-limiting implementations and that the scope of the present invention is defined solely by the claims. The features illustrated or described in connection with one implementation may be combined with the features of other implementations. Such modifications and variations are intended to be included within the scope of the present invention.

Further, in the present disclosure, like-named components of the implementations generally have similar features, and thus within a particular implementation each feature of each like-named component is not necessarily fully elaborated upon.

As described, signal processing techniques, such as time synchronous averaging, can be used to reduce or remove unwanted noise from sensor signals before the signals undergo further analysis. However, complexities can arise when attempting to remove noise from certain types of sensor signals (e.g., magnetostrictive sensor signals, seismic sensor signals, eddy current probe signals, etc.) in real-time or on a continuous basis using existing signal processing techniques. For example, removing electrical or mechanical runout signatures from a signal produced by a sensor that measures a rotating shaft using traditional noise removal methods is often computationally inefficient or ineffective due to the tendency of the runout signatures to vary under different operating conditions.

Disclosed herein are methods, systems, and non-transitory computer readable storage media that leverage a discounted averaging process to enable continuous reduction or removal of noise in sensor signals. A sensor signal can be provided to a discounted averaging processing system by a sensor (e.g., a magnetostrictive sensor, an accelerometer, an eddy current probe, etc.) that is configured to detect a variable physical property (e.g., a time-varying physical property, a frequency-varying physical property, a physical property that varies spatially, or the like) of a target (e.g., a machine component such as a gear, a shaft, or the like). The discounted averaging processing system can apply the discounted averaging process, in combination with reference data provided by, e.g., a phase reference generator such as a tachometer, to remove periodic or harmonic noise from the sensor signal. Once the noise is removed, the noise-reduced sensor signal can be output by the discounted averaging processing system for further analysis or processing.

The discounted averaging process that is employed by the described methods, systems, and non-transitory computer readable storage media can allow unwanted noise to be effectively and computationally-efficiently removed from sensor signals. As a result, the described methods, systems, and non-transitory computer readable storage media can be implemented to continuously process signal data with minimal computational overhead and can enable meaningful information to be extracted even from those types of sensor signals (e.g., magnetostrictive sensor signals) that cannot be effectively or efficiently processed using traditional noise removal processes (e.g., time synchronous averaging).

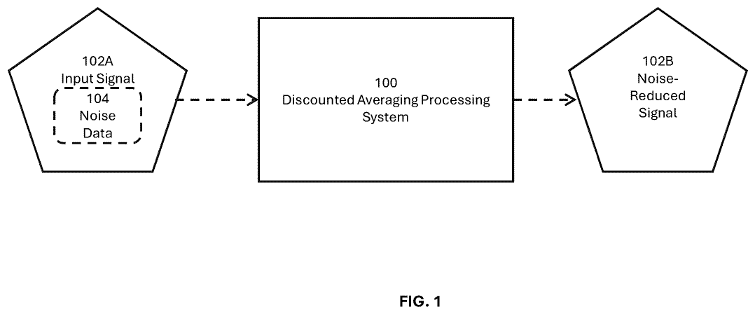

FIG. 1 is a block diagram illustrating an example input and corresponding output to a discounted averaging processing system 100. As shown, the discounted averaging processing system 100 can receive as input a signal 102A. The signal 102A can be a sensor signal produced by a sensor that is configured to detect a variable physical property of a target object. For example, the signal 102A can be a magnetostrictive sensor signal produced by a magnetostrictive sensor that is configured to detect torsional vibration of a rotating shaft. The signal 102A received by the system 100 can include noise data 104, for example, data resulting from electrical or mechanical runout. The discounted averaging processing system 100 can be configured to automatically process the input signal 102A to remove the noise data 104, thereby producing an output signal 102B. The output signal 102B can be a noise-reduced signal that includes the relevant information contained in the signal 102A (e.g., can include information regarding the variable physical property detected by the sensor) and exclude the noise data 104 contained in the signal 102A.

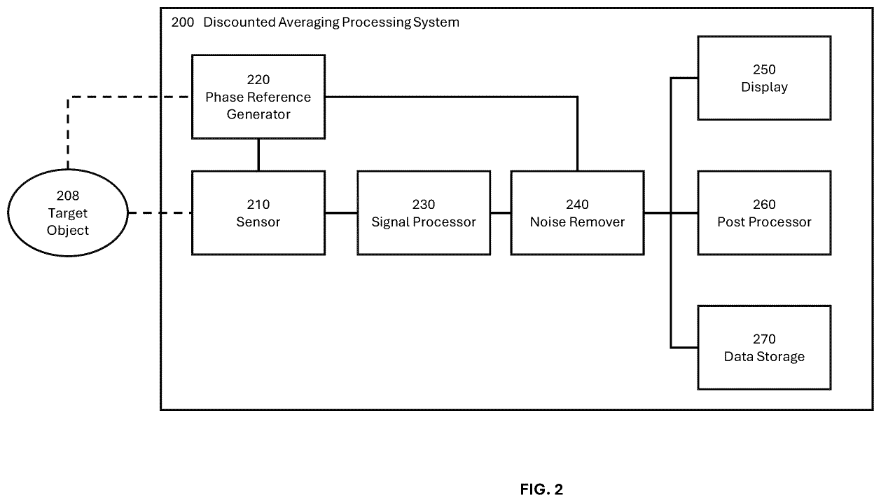

FIG. 2 is a block diagram illustrating an exemplary embodiment of a discounted averaging processing system 200. In some aspects, the system 200 can be similar to the system 100 of FIG. 1. In this embodiment, the discounted averaging processing system 200 includes a sensor 210, a phase reference generator 220, a signal processor 230, a noise remover 240, a display 250, a post processor 260, and data storage 270.

The system 200 of FIG. 2 is intended only as an example of a discounted averaging processing system. Those skilled in the art will appreciate that, in some embodiments, a discounted averaging processing system can include components that are not included in the system 200 of FIG. 2, and, in some embodiments, a discounted averaging processing system can lack components that are included in the system 200 of FIG. 2.

The sensor 210 can be any suitable device or combination of devices configured to detect a variable physical property of a target object 208. Example devices that can be used to implement the sensor 210 include (but are not limited to) magnetostrictive sensors, seismic sensors (e.g., accelerometers, velometers, etc.), pressure transducers, and/or eddy current probes. The variable physical property detected by the sensor 210 can be a time-varying property, a frequency-varying property, a spatially-varying property, or the like. Examples of a variable physical property that can be detected by the sensor 210 include (but are not limited to) vibrational torsion, radial vibration, axial vibration, acoustic vibration, dynamic pressure changes, and/or inductance.

The target object 208 can be a mechanical component of a machine that is in motion when the machine is in use. For example, the target object 208 can be a rotating shaft, a gear, a spring, a structural member or a chamber that contains a fluid (e.g., a combustion chamber), or the like.

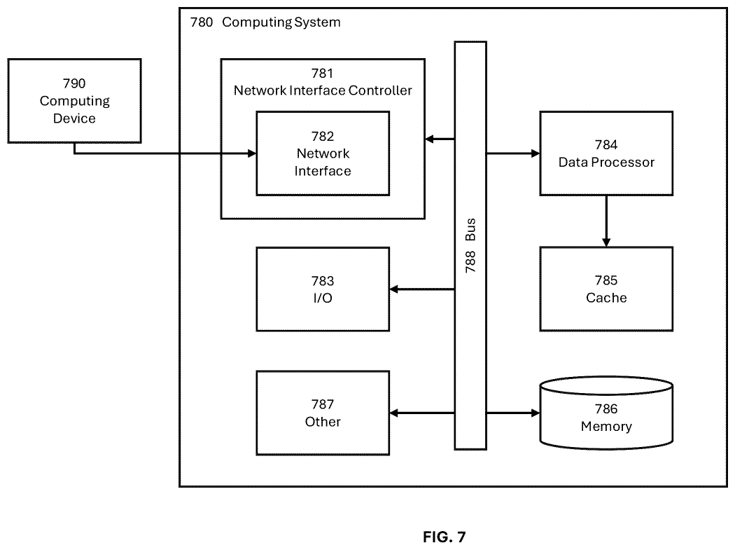

The phase reference generator 220 can be any suitable device or component configured to provide reference information representative of a noise feature of signals produced by the sensor 210. The phase reference generator 220 can include hardware components, software components, or a combination thereof. For example, in some embodiments, the phase reference generator 220 can be a second sensor, such as a tachometer. In some embodiments, the phase reference generator 220 can be a computer program that includes computer-readable instructions configured to cause a data processor (e.g., a CPU or another suitable processing device) to derive, generate, or simulate the phase reference information. If the phase reference generator 220 includes software components, these components can be implemented using any suitable computer system that includes at least one data processor and a memory device. Additional description of an exemplary computer system configured for use in regard to the subject matter herein is provided with respect to FIG. 7.

In some implementations, if the sensor 210 samples at a fixed sampling rate, the phase reference generator 220 can be configured to computationally derive the phase reference information using a common multiple between the fixed sampling rate and a frequency of interest. For example, if the sampling rate of the sensor 210 is 128 kHz, and the frequency of interest is 1 kHz, the phase reference generator 220 can be configured to generate phase reference information that includes a 0-phase reference every 128 samples. In some implementations, the phase reference generator 220 can be configured to detect a peak of a waveform provided by the sensor 210 to derive the phase reference information.

In some implementations, the phase reference generator 220 can be configured to receive or extract the phase reference information from the moving target 208. For example, the phase reference generator 220 can be configured to measure or detect a property of the moving target 208 that is indicative of a noise feature of signals produced by the sensor 210. In other implementations, the phase reference generator 220 can be coupled to the sensor 210 and configured to generate the phase reference information based on information received from the sensor 210.

The signal processor 230 can be communicatively coupled to the sensor 210. The signal processor 230 can be any suitable device or component configured to process signals provided by the sensor 210. The signal processor 230 can include hardware components, software components, or a combination thereof. In some implementations, the signal processor 230 can be a dedicated physical module configured to perform various functions (e.g., filtering, demodulating, measuring signal parameters, and the like) to pre-process signals provided by the sensor 210. In some embodiments, the signal processor 230 can include a digital signal processor (DSP).

The noise remover 240 can be communicatively coupled to the phase reference generator 220 and to the sensor 210 (e.g., through the signal processor 230). The noise remover 240 can be any suitable device or component configured to reduce or remove noise data from signals provided by the sensor 210. The noise remover 240 can be or include a computer program comprising computer-readable instructions configured to cause a data processor (e.g., a CPU or other suitable processing device) to use a discounted averaging process, in combination with phase reference information provided by the phase reference generator 220, to process signals provided by the sensor 210 to extract the relevant physical property data contained in the signals and to reduce or remove the noise data contained in the signals to produce a noise-reduced sensor signal. The noise remover 240 can be implemented using any suitable computer system that includes at least one data processor and a memory device. Additional description of an exemplary computer system configured for use in regard to the subject matter herein is provided with respect to FIG. 7.

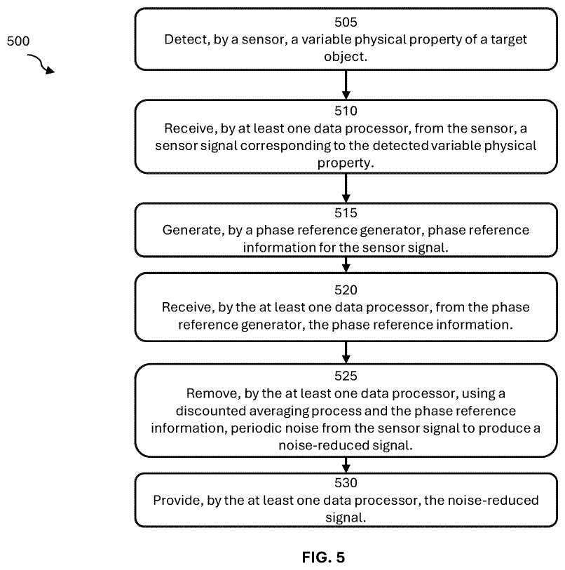

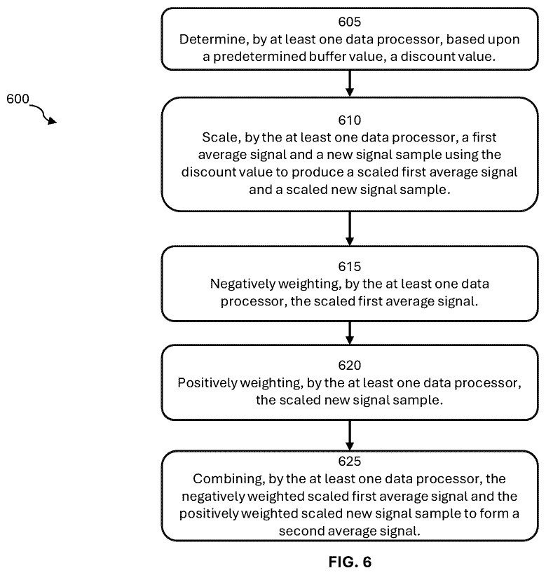

In some implementations, the noise remover 240 can be implemented using a computational device with limited available memory and processing capacity. For example, the noise remover 240 can be implemented using a field programmable gate array (FPGA) or an application specific integrated circuit (ASIC) that is configured to use a discounted averaging process, in combination with phase reference information provided by the phase reference generator 220, to process signals provided by the sensor 210 to reduce or remove the noise data contained in the signals to produce a noise-reduced sensor signal. As explained in further detail herein (e.g., with respect to FIGS. 5-6), as a result of the discounted averaging process, the noise remover 240 can efficiently remove noise data from sensor signals without having to retain or process large sets of data. The noise remover 240 therefore enables computationally efficient removal of noise data from sensor signals.

The display 250 can be communicatively coupled to the noise remover 240 (e.g., to the computer system used to implement the noise remover 240). The display 250 can be any suitable device or combination of devices configured to display data such as a noise-reduced sensor signal provided by the noise remover 240. Example devices that can be used to implement the display 250 include (but are not limited to) computer monitors, LCD displays, LED displays, touchscreen displays, and the like. In some embodiments, the display 250 can be or can include a software display system.

The post processor 260 can be communicatively coupled to the noise remover 240 (e.g., to the computer system used to implement the noise remover 240). The post processor 260 can be any suitable device or combination of devices for automatically performing additional processing or analysis of noise-reduced signals provided by the noise remover 240. The post processor 260 can be implemented using any suitable computer system that includes at least one data processor and a memory device. In some embodiments, the post processor 260 can be implemented using the same computer system used to implement the noise remover 240. In some embodiments, the post processor 260 can be implemented using a computer system that can be coupled to the noise remover 240, e.g., by a wired or a wireless network. In some embodiments, the post-processor 260 can be configured to perform tasks such as peak-to-peak measurements of noise-reduced signals or spectrum analyses of noise-reduced signals. In some embodiments, the post-processor 260 can be configured to perform time-based processing tasks such as, e.g., cycle counting for fatigue analysis.

Data storage 270 can be communicatively coupled to the noise remover 240 (e.g., to the computer system used to implement the noise remover 240). Data storage 270 can be any suitable device, component, or combination of devices and/or components for storing noise-reduced signals provided by the noise remover 240. For example, data storage 270 can be cloud storage, block storage, object storage, flash memory, optical storage, an external hard drive, or the like. In some embodiments, data storage 270 can be the memory of the computer system used to implement the noise remover 240.

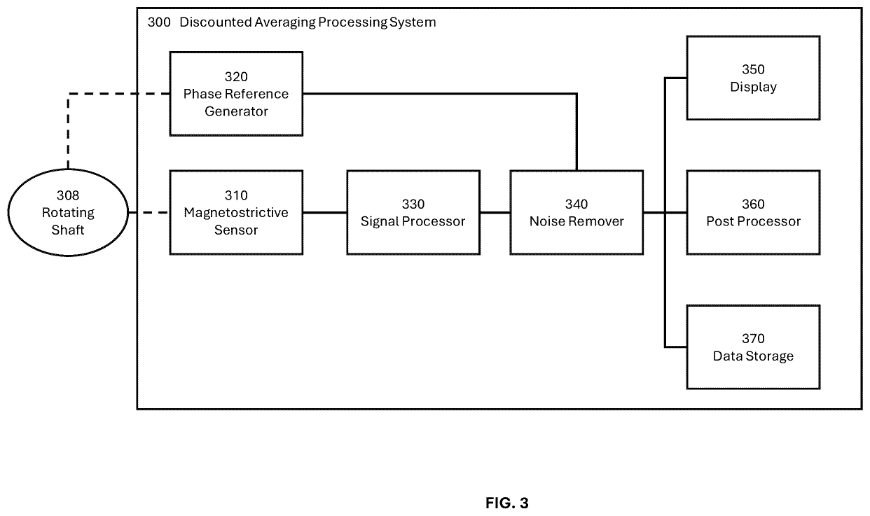

FIG. 3 is a block diagram illustrating another exemplary embodiment of a discounted averaging processing system 300. In some aspects, the discounted averaging processing system 300 can be similar to the discounted averaging processing system 200 of FIG. 2, accordingly, like components are not described. In this embodiment, the discounted averaging processing system 300 includes a magnetostrictive sensor 310 that can be configured to detect a variable physical property of a rotating shaft 308. The system 300 also includes a phase reference generator 320, a signal processor 330, a noise remover 340, a display 350, a post processor 360, and data storage 370, which can, respectively, be substantially similar to the phase reference generator 220, the signal processor 230, the noise remover 240, the display 250, the post processor 260, and data storage 270 of the system 200 shown in FIG. 2.

The system 300 of FIG. 3 is intended only as an example of a discounted averaging processing system. Those skilled in the art will appreciate that, in some embodiments, a discounted averaging processing system can include components that are not included in the system 300 of FIG. 3, and, in some embodiments, a discounted averaging processing system can lack components that are included in the system 300 of FIG. 3.

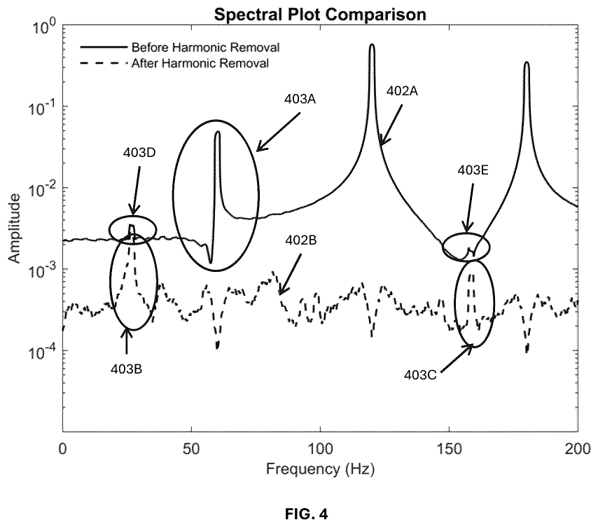

FIG. 4 provides a plot comparing an example sensor signal waveforms before and after noise removal by a discounted averaging processing system such as the system 200 shown in FIG. 2 or the system 300 shown in FIG. 3. As shown, the noise-reduced signal waveform 402B that is output by the discounted averaging processing system following noise (“harmonic”) removal includes information that was obscured in the signal waveform 402A prior to noise removal. The signal waveform 402A prior to noise removal includes features such as, e.g., the amplitude spike 403A, resulting from noise. The discounted averaging processing system can efficiently and effectively reduce or remove such noise signatures to produce the noise-reduced signal waveform 402B.

In this example shown in FIG. 4, the noise-reduced signal 402B includes several amplitude spikes (e.g., 403B, 403C). While these amplitude spikes are also present (403D, 403E) in the non-noise-reduced signal 402A, they are less pronounced. As a result, in the non-noise-reduced signal 402A, it is not apparent whether the amplitude spikes 403D, 403E indicate signal features of potential interest for further analysis. In the noise-reduced signal 402B, the amplitude spikes 403B, 403C are more pronounced. The noise-reduced signal 402B therefore clearly indicates features that may benefit from further inspection and analysis.

FIG. 5 is a flowchart illustrating an exemplary method 500 of leveraging a discounted averaging process to reduce or remove noise in sensor signals. The method 500 of FIG. 5 can be executed by a discounted averaging processing system such as the system 100 of FIG. 1, the system 200 of FIG. 2, or the system 300 of FIG. 3. In general, the method 500 can enable computationally efficient, real-time or continuous discarding of noise and extracting of relevant information from sensor signals.

The method 500 of FIG. 5 is intended only as an example of a method of leveraging a discounted averaging process to reduce or remove noise in sensor signals. Those skilled in the art will appreciate that, in some embodiments, a method of leveraging a discounted averaging process to reduce or remove noise in sensor signals can be executed in a different order than the method 500 of FIG. 5. Additionally, in some embodiments, a method of leveraging a discounted averaging process to reduce or remove noise in sensor signals can include portions that are not included in the method 500 of FIG. 5, and in some embodiments, a method of leveraging a discounted averaging process to reduce or remove noise in sensor signals can omit portions that are included in the method 500 of FIG. 5.

At 505, a sensor can detect a variable physical property of a target object. The sensor can be generally similar to, e.g., the sensor 210 of the system 200 shown in FIG. 2 or the sensor 310 of the system 300 shown in FIG. 3. The target object can be a mechanical component of a machine that is in motion when the machine is in use, for example a rotating shaft. The variable physical property detected by the sensor can be a time-varying property, a frequency-varying property, a spatially-varying property, or the like.

At 510, a sensor signal corresponding to the variable physical property detected by the sensor can be received, from the sensor, by at least one data processor. The data processor can be a processor of a computer system used to implement a noise remover such as the noise remover 240 of the system 200 shown in FIG. 2 or the noise remover 340 of the system 300 shown in FIG. 3.

In some embodiments, the processing power, processing speed, and/or available computer memory associated with the data processor can depend upon characteristics of the motion of the target object. For example, if the target object is a rotating shaft, the processing power, processing speed, and/or computer memory associated with the data processor can depend upon the speed (e.g., the rotation speed) of the shaft. In some embodiments, the data processor can be an FPGA, an ASIC, or another specialized processing device.

At 515, a phase reference generator (e.g., the phase reference generator 220 of the system 200 shown in FIG. 2 or the phase reference generator 340 of the system 300 shown in FIG. 3) can generate phase reference information for the sensor signal. The phase reference information can include information representative of a noise feature of the sensor signals. The data processor can receive, at 520, the phase reference information form the phase reference generator.

Once the sensor signal and the phase reference information are received, the data processor can use a discounted averaging process, in combination with the phase reference information, to remove periodic noise from the sensor signal and produce a noise-reduced signal (525). In some embodiments, leveraging the discounted averaging process can allow the data processor to efficiently account for sensor signal fluctuations caused by, e.g., changes in the motion (e.g., the speed) of the target object being measured by the sensor, without the processor needing to compare the sensor signal to large sets of previously collected sensor data (e.g., sensor data corresponding to more than two rotations of a rotating shaft). As a result, the data processor can efficiently and effectively identify and extract the noise data from the sensor signal even if the processor has access only to small amounts of computer memory (e.g., if the amount of computer memory is less than an amount required to store sensor signal data corresponding to three rotations of a rotating shaft).

FIG. 6 is a flowchart illustrating an exemplary discounted averaging process 600 that can be used by the data processor to produce the noise-reduced signal.

As shown, at 605, the data processor can determine, based upon a predetermined buffer value N, a discount factor D. The buffer value N can correspond to an amount of sensor signal data that will be used to determine the real-time average of the sensor signal provided by the sensor. In some implementations, the discount factor can be given by Equation 1:

$$D = \frac{N - 1}{{N}^{2}} \qquad ( 1 )$$

At 610, the processor can use the discount value D to scale a first average signal X̅_̅{̅P̅}̅ and a new signal sample X_{N} to produce a scaled first average signal and a scaled new signal sample. The new signal sample X_{N} can include newly received, unprocessed signal data received from the sensor. The first average signal X̅_̅{̅P̅}̅ can be a previously determined average of signal samples received immediately prior to the new signal sample X_{N}. In some implementations, the first average signal X̅_̅{̅P̅}̅ can be approximated as shown in Equation 2:

$$\overline{{X}_{P}} \approx {\sum }_{i = 1}^{N - 1} {x}_{i} \qquad ( 2 )$$

At 615, the processor can negatively weight the scaled first average signal. At 620, the processor can positively weight the scaled new signal sample. At 625, the processor can combine the negatively weighted scaled first average signal and the positively weighted scaled new signal sample to form a second average signal X̅_̅{̅N̅}̅. The second average signal can represent a current average of the sensor signal provided by the sensor. In some implementations, the second average signal X̅_̅{̅N̅}̅ can be given by Equation 3:

$$\overline{{X}_{N}} = ( \frac{1}{N} + D ) {X}_{N} + ( \frac{N - 1}{N} - D ) \overline{{X}_{P}} \qquad ( 3 )$$

Referring again to FIG. 5, the real-time average of the sensor signal that is determined using the discounted averaging process can be used by the processor to produce the noise-reduced sensor signal. In some embodiments, the sensor signal can include a first array of values, and the real-time average of the sensor signal can be a second array of values. The processor can identify the noise data contained in the sensor signal by determining data indicating a difference between the first array and the second array and storing said information as a third array. The processor can use the phase reference information to determine a shape or a size of this third array. For example, the processor can use the phase reference information to determine an amount of data that should be contained in the third array.

After the noise-reduced signal is produced (525), the processor can provide the noise-reduced signal as output (530). In some embodiments, the processor can control or otherwise communicate with a display (e.g., the display 250 shown in FIG. 2, the display 350 shown in FIG. 3, etc.) to display a visual representation of the noise-reduced signal such as, e.g., a plot of a waveform of the noise reduced signal. In some embodiments, the processor can perform additional post-processing on the noise-reduced signal data, for example to determine whether the variable physical property of the target object measured by the sensor is within an acceptable range. Additionally or alternatively, the processor may transmit the noise-reduced signal to another processor (e.g., a processor of another computer system) for post-processing. In some embodiments, the processor can store the noise-reduced signal in data storage such as, e.g., data storage 270 of FIG. 2 or data storage 370 of FIG. 3.

FIG. 7 is a block diagram illustrating exemplary computer system 780 according to the systems and methods described herein. The computer system 780 can be used in conjunction with or can be a component of discounted averaging processing systems such as the system 100 described with respect to FIG. 1, the system 200 described with respect to FIG. 2, and the system 300 described with respect to FIG. 3 and can be configured to execute one or more portions of methods such as the method 500 described with respect to FIG. 5 and the method 600 described with respect to FIG. 6. As shown in FIG. 7, the computing system 780 can include a network interface controller 781, input/output (I/O) devices 783, at least one data processor 784, a cache 785, and memory 786.

The processor 784 can be any logic circuitry that processes computer readable instructions, e.g., instructions fetched from the memory 786 or the cache 785. In some embodiments, the processor 784 is an embedded processor, a microprocessor, a digital signal processor, or a special purpose processor. In some embodiments, the processor 784 is a single core. In some embodiments, the processor 784 is a multi-core processor. In some embodiments, the processor 784 includes multiple processing units.

The memory 786 can be any device suitable for storing computer readable data. For example, the memory 786 can be a device with fixed storage or a device for reading removable storage media. In some embodiments, the memory 786 can include non-volatile memory, media and memory devices, semiconductor memory devices (e.g., EPROM, EEPROM, SDRAM, flash memory devices, and all types of solid-state memory), magnetic disks, and magneto-optical disks. The computing system 780 can include any number of memory devices.

The cache memory 785 can be any suitable high-speed computer memory arranged relative to the processor 784 to enable fast reading and writing of data by the processor 784. In some implementations, the cache memory 785 is part of, or on the same chip as, the processor 784.

The network interface controller 781 can be any suitable device or combination of devices for managing data exchanges via a network interface 782. In some embodiments, the network interface controller 781 can be configured to control the physical, media access control, and data link layers of an Open Systems Interconnect (OSI) model for network communication. In some implementations, the network interface controller 781 is a component of the processor 784. In some implementations, the computing system 780 includes multiple network interface controllers 781.

The network interface 782 can be or include a connection point for a physical network link, e.g., an RJ 45 connector, a network interface port for supporting wireless network connections, or combinations thereof. The computing system 780 can exchange data with other network devices, such as a computing device 790, via physical or wireless links to the network interface 782. In some embodiments, the network interface controller 781 can implement a network protocol such as LTE, TCP/IP Ethernet, IEEE 802.11, IEEE 802.16, or the like.

The computing device 790 can be a peer computing device, a network device, or any other computing device with network functionality. For example, the computing device 790 can be a remote controller or a remote display device configured to communicate and operate the systems described herein remotely. In some embodiments, the computing device 790 can include a server or a network device such as a hub, a bridge, a switch, or a router, connecting the computing device 790 to a data network such as the Internet.

The I/O devices 783 can support an input device (e.g., a keyboard, a mouse, a touchscreen, etc.) and/or an output device (e.g., a monitor, a speaker, etc.). In some embodiments, the input device and the output device are integrated into the same hardware, e.g., as in a touchscreen. In some embodiments, such as in a server context, there are no I/O devices 783, or the I/O devices 783 may not be not used.

In some implementations, additional other components 787 can be included in or can be in communication with the computing system 780. For example, external devices can be connected to the computing system 780 via a universal serial bus (USB). In some implementations, the additional components 787 can include a co-processor, e.g., a math co-processor that can assist the processor 784 with high precision or complex calculations.

Certain exemplary embodiments have been described to provide an overall understanding of the principles of the structure, function, manufacture, and use of the systems, methods, and non-transitory computer readable storage media disclosed herein. One or more examples of these embodiments have been illustrated in the accompanying drawings. Those skilled in the art will understand that the systems, methods, and non-transitory computer readable storage media described herein and illustrated in the accompanying drawings are exemplary embodiments that are not intended to limit the scope of the description. The features illustrated or described in connection with any given embodiment may be combined with the features of other embodiments. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the methods described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

1. A method comprising:
receiving, by at least one data processor, from a sensor configured to detect a variable physical property of a target object, a sensor signal corresponding to the detected variable physical property;
receiving, by the at least one data processor, from a phase reference generator, phase reference information representative of a noise feature of the sensor signal;
removing, by the at least one data processor, using a discounted averaging process and the phase reference information, periodic noise from the sensor signal to produce a noise-reduced signal; and
providing, by the at least one data processor, the noise-reduced signal.

2. The method of claim 1, wherein the sensor is a magnetostrictive sensor.

3. The method of claim 1, further comprising:
detecting, by the sensor, the variable physical property.

4. The method of claim 1, wherein the target object is a rotating shaft.

5. The method of claim 1, wherein the variable physical property is a time-varying physical property, a frequency-varying physical property, or a spatially-varying physical property.

6. The method of claim 1, wherein the variable physical property is a torsional vibration of the target object.

7. The method of claim 1, wherein providing the noise-reduced signal comprises:
controlling, by the at least one data processor, a display to display a waveform corresponding to the noise-reduced signal.

8. The method of claim 1, wherein providing the noise-reduced signal comprises:
storing, by the at least one data processor, the noise-reduced signal in a data storage device.

9. A system comprising:
at least one data processor; and
non-transitory memory storing instructions configured to be executed by the at least one data processor to cause the at least one data processor to perform operations comprising:
receiving, from a sensor configured to detect a variable physical property of a target object, a sensor signal corresponding to the detected variable physical property;
receiving, from a phase reference generator, phase reference information representative of a noise feature of the sensor signal;
removing, using a discounted averaging process and the phase reference information, periodic noise from the sensor signal to produce a noise-reduced signal; and
providing the noise-reduced signal.

10. The system of claim 9, further comprising the sensor.

11. The system of claim 9, wherein the sensor is an eddy current probe.

12. The system of claim 9, wherein the target object is a rotating shaft.

13. The system of claim 9, wherein the variable physical property is a time-varying physical property, a frequency-varying physical property, or a spatially-varying physical property.

14. The system of claim 9, further comprising:
a signal processor configured to process the sensor signal before the sensor signal is received by the at least one data processor.

15. The system of claim 12, wherein the signal processor is a digital signal processor.

16. The system of claim 9, further comprising:
a display communicatively coupled to the at least one data processor.

17. The system of claim 16, wherein providing the noise-reduced signal comprises:
controlling, by the at least one data processor, the display to display a waveform corresponding to the noise-reduced signal.

18. The system of claim 9, further comprising a second computer system configured to process the noise-reduced signal.

19. The system of claim 18, wherein the second computer system is communicatively coupled to the at least one data processor through a network.

20. A non-transitory computer-readable memory storing instructions which, when executed by at least one data processor, cause the at least one data processor to perform operations comprising:
receiving, from a sensor configured to detect a variable physical property of a target object, a sensor signal corresponding to the detected variable physical property;
receiving, from a phase reference generator, phase reference information representative of a noise feature of the sensor signal;
removing, using a discounted averaging process and the phase reference information, periodic noise from the sensor signal to produce a noise-reduced signal; and
providing the noise-reduced signal.
